(19) United States
(12) Patent Application Publication
(10) Pub. No.: US 2013/0326333 A1
(43) Pub. Date: Dec. 5, 2013

(54) Mobile Content Management System

(71) Applicant: Atiq Hashmi, Sayerville, NJ (US)

(72) Inventor: Atiq Hashmi, Sayerville, NJ (US)

(21) Appl. No.: 13/908,536

(22) Filed: Jun. 3, 2013

Related U.S. Application Data
(60) Provisional application No. 61/654,225, filed on Jun. 1, 2012.

(51) Int. Cl. G06F 17/22

(52) U.S. Cl. CPC G06F 17/2247
USPC 715/234

(57) ABSTRACT

A system, method, and apparatus for a Mobile Content Management System that has interactive features to enable creation of Mobile Website are described. The MCMS software is cloud-based, but other versions may include standalone software that can be installed on a user's desktop or a mobile device such as a tablet or a smartphone. The system allows creating new mobile content as well as converting existing desktop websites into mobile device compatible versions. The system is delivered ON a SaaS (Software as a Service) platform on a hosting server. A user interacts with the system and utilizes various features and interfaces in the system to create the mobile website for consumption by a variety of mobile devices.

### PRIORITY

This application claims priority to U.S. Ser. No. 61/654,225 filed Jun. 1, 2012, the contents of which are fully incorporated herein by reference.

### FIELD OF THE INVENTION

A system, method, and apparatus for creating and maintaining optimized and stylized website content for mobile devices.

### BACKGROUND OF THE INVENTION

The arrival of mobile devices in the last decade that can receive and process data has provided users on the go the ability to receive information (besides making phone calls) on their mobile devices.

The smartphone introduction has created a new industry of mobile computing and Application development. A major use of the smartphones is to download and run Applications that are built for the device's native platforms. Another major use of the smartphones is the ability to access and browse full websites. Advanced phones built on iOS and Android etc. have zoom, pinch and pan capabilities that allow viewing the full website content. However, as more and more users are using their smartphones on a regular basis, doing this for every website and every page of each website is very tedious and time consuming. Therefore in the last few years, a trend has developed about optimizing regular desktop websites into mobile compatible versions for easy interaction and efficiency as well new features now possible with various hardware capabilities of these phones.

Creating a mobile optimized version involves technical knowhow in the mobile web design. It involves learning a significant amount of new concepts and technology to develop fully functional and well-performing websites that work on the mobile devices.

For businesses and individuals, gaining the knowhow to create mobile optimized versions of their websites is a challenge. In the desktop website world which has been around for two decades, many tools and platforms have been developed that allow users of moderate web or technology savvy to build their websites themselves. These tools have some supported plugins or modules to cater to mobile devices, but are at best plugins and not comprehensive tools. At the same time, in the mobile world, very few such tools exist that are mobile specific.

Mobile website development has several needs and resulting challenges. First is the ability to easily and quickly create a mobile site. Second, rich website content development features are needed. Third, the ability to keep the desktop and mobile websites synchronized when the desktop content is updated. Fourth, the invention has the ability to use selective content from a desktop website to be shown on the mobile device. Fifth, the ability to add custom content (e.g. a personal or group activity related content such as a community, sports, networking club information etc.) that may not exist as a desktop website. Sixth, the ability to rapidly create a mobile using plug and play features. Seventh, the invention has the ability to support both desktop website content and custom content simultaneously in the same mobile website. Eighth, the ability to extend the capability of the mobile website by plugins to enable various kinds of businesses owning the mobile website to leverage this medium for a variety of business strategies.

While there are some tools available today, they lack in one or more of the above listed needs. Therefore, a significant need exists to provide all the aforementioned capabilities in one system that allows for businesses and individuals to create, maintain, synchronize and benefit from rich content catering to their needs and artistic styles. The invention described in this document addresses all the above needs as well as other features, like synchronization frequency settings and one-time sync run etc., in one system.

The prior art disclosed in patent US2004/0107403 suggests a few types of content transformation on the fly where images are generally filtered out or transformed if they do not confirm to a certain size supported by the device, stylesheet is modified to support device width. This prior art is limited to on the fly conversions and processing of the conversion in the terminal device terminal.

The prior art disclosed in patent US 2005/0060648 is based on a mapping between a list of desktop site layouts and a library of mobile layouts, where the layout is selected based on device characteristics.

The prior art disclosed in patent US2006/0059462 A1 addresses a browser panel on a special consumer equipment such as a multi-function printer panel where the page content is adapted to the panel screen. It addresses a specialized system of hardware and software where the browser interacts with the equipment software displays specific types of webpages e.g. user manual, promotional or warning messages upon detecting certain hardware conditions such as toner low.

The prior art disclosed in patent US2009/0222475A1 addresses a very specific type of web content transformation into mobile format. The specific web content is code picker popups e.g. calendar or airport codes to choose a value from. The specific idea disclosed here is addressing the limitation on some device browsers that do not support multiple pages opened. This prior art is specific to the handling of these popups as pages showing the picker values, and upon a selection, the previous page form is filled. It does not provide a full-scale Content Management System.

The prior art disclosed in patent US2010/0199197 and 12621914 address selective content method to select from a desktop website and include into a mobile website. It provides support for selecting content and then placing in receiving templates with ability to modify the content and its style. The tracking only comprises of indexing the location of the HTML content block (such as XPath references). This prior art does not indicate the maintenance of the mobile website as a cached site which will result in processing to search every indexed block content at run time thus seriously impacting performance and user experience. On the other hand, if the prior art even supports caching, there is no solution presented for maintaining synchronization between the source website and the cached mobile website.

Evaluating prior art, all existing art provide one or more facets of mobile website generation technology but do not provide a comprehensive solution of a scalable Content Management System that can support a variety of situations and market needs. They do not offer one or more of the following methods: rich media editing facility with HTML/CSS support, plugin extensibility and seamless integration into mobile site development, embedded link processing to enable mobile optimization of any number of pages on a desktop site, coexistence of PC and custom content, 1-click template selection and switching method, Auto-synchronization between source (desktop) website and mobile website, API Adapter to receive content from another system to generate a mobile website, 1-click site regeneration, custom rich media content insertion that does not exist on the desktop website, co-existence of desktop synchronized and custom content in one page, and ability to either setup and serve the resulting mobile website from the integrated MCMS cloud server environment or extract as a stand-alone mobile website package deployable on any other hosting environment. These capabilities are further described in the following document.

### BRIEF DESCRIPTION OF THE DRAWINGS

FIG. 1 is a high level block diagram of an exemplary system according to the present invention.

FIG. 2 is a block diagram showing an embodiment and important components of the high level exemplary system in FIG. 1.

FIG. 2a is a block diagram showing an exemplary system showing the Mobile Website Designer.

FIG. 2b through 2d are some code samples of some of the transformation by the Media Optimizer.

FIG. 3 is an embodiment of a high level Use case scenario showing important functioning steps in the creation and display of a mobile website.

FIG. 4a represents one approach of auto-synchronization processing.

FIG. 4b represents another approach of the auto-synchronization processing.

FIG. 5 is a flowchart representing the novel techniques and steps in an exemplary method for creating mobile website content that can be tracked for auto-synchronization

FIG. 6 is a flowchart representing the steps taken by the backend job that will keep the mobile website content synchronized with the desktop content.

### SUMMARY

A system, method, and apparatus for a Mobile Content Management System, referred to in this document as MCMS, that has interactive features to enable creation of Mobile Website (herein referred to as MW) are described. The current embodiment of the MCMS software is cloud-based, but other embodiments may include standalone software that can be installed on a user's desktop or a mobile device such as a tablet or a smartphone.

The system may include an intelligent template management module providing pre-designed MW templates for stylized content rendering and for serving as MW content containers; the templates further providing adaptability of layout configuration and styles among a set of compatible templates with an easy to use action such as one-click operation. The templates may be grouped in various ways such as by style, by target industry, or by features etc.

The system may include a rich editor integration into the MCMS for visual and Hypertext Markup language, or HTML for short, editing and representation of content that supports a variety of content types including but not limited to, text in a variety of fonts and styles such as bold, italics, font-weight, etc., images, graphics, video etc.; the rich editor integration further supporting multiple ways for quick and easy incorporation of content from another content source as well as creating new custom content.

The method may include launching a child web browser, loading a web page for a specified Uniform Resource Locator, such as a web page address like http://www.webpage.com, and communicating with it to capture content and underlying structure data of the page. A child web browser is a web page browsing window opened within the context of another currently-opened browser running the MCMS application. The child window is capable of displaying a web page specified with a URL and in one embodiment can be implemented using an iframe HTML element. A user interacting with the MCMS user interface can use a method on the interface such as a right-click or a menu option to launch the child browser. The child browser is then controlled with program instructions as part of the MCMS software to enable a user to highlight content blocks such as paragraphs or images etc. during mouse events such as hovering then process those content blocks to store and index. In another embodiment of the selective content marking technique, instead of automatic highlighting of content blocks for user to choose from while the user moves the pointer device such as a mouse, the user may be provided ability to select by a click-and-drag action of the pointer device to highlight exactly the content blocks desired for inclusion in the MW page.

The method may include creating a visual interface in the child web browser to mark and capture full or selective content on the pages of an online website, henceforth referred to as the external source in this document, in the customer designated order.

The method may include indexing the location and structural attributes of the marked content in an external source and storing in storage to subsequently allow accurately locating those marked content blocks. In one embodiment, the method may include creating a MW as a ready-made site containing a copy of content for another site as well as custom content.

In another embodiment, the method may include the indexing and structural attributes and fetching the content from another site and placing in the MW template at run-time, such as when a mobile device requests the MW content.

The method may include integration of custom content created by a user using the rich editor in the MCMS and the marked and captured block content from external source and maintenance of the two types of content in a single MW.

The method may involve extending the functionality of the MCMS by incorporating plugins to add pre-designed as well as custom development features to a MW. These plugins may contain features such as a well-formatted contact info page feature showing information like business entity name, address, phone, email, location map, route calculation etc., QR code generation feature, survey feature supporting survey form creation, response recording, and reporting, marketing feature such as coupons, e-commerce feature etc.

The invention may support the ability to add plugins or extensions to extend the capability and use of mobile website. The system provides ability to add and configure new plugins on an ongoing basis. The mechanism to provide this is as follows: A software developer skilled in the art may create a web Application module built using standard web programming technologies such as HTML, CSS, Javascript, Ajax etc. suitable for a web browser on a mobile device usage such as a mortgage calculator, or a location based search feature etc. The application may then be configured in the MCMS as a plugin and shown on the MCMS software as one of the extensions to include. A mobile web site designer person may choose the plugin to insert into one of the pages as a link which may take any clickable form such as a link, a menu option, or a button, or an image etc. The code and functionality becomes integrated into the mobile website and is accessible to the users of the mobile website for use. The plugin may be programmed in such a way that enables accessing the mobile device hardware for resources such as camera, the storage medium on the device, location-based features such as the Global Positioning Service device embedded on the system. This type of hardware accessing plugin may user a plurality of technologies available to enable hardware access from the web browser on the mobile phone. In this respect, the mobile website created using this invention really offers a mobile App experience.

The system may include a synchronization server to keep in sync the real-time version of the content obtained from the external source and the copied version of that content in the MW; the synchronization server further using heuristics and statistics to support efficient processing during the synchronization process.

The method may include providing a portal to host a plurality of MW projects each created with the MCMS software.

The method may include optimizing media files including images, graphics, video files using algorithms, heuristic rules, statistics, and calculations.

The method may include steps to configure Domain Name System, also referred to as DNS, on other web server hosts to point a subdomain such as ‘m’ e.g. m.domain.com, to point to the web server host hosting the MW's created by use of MCMS; the method further may include steps to configure the hosting web server to point the incoming requests for accessing the MW to the folder where the generated MW is installed. The web server hosting the MW's may be the same as the web server running the MCMS software.

The method may include steps to configure an existing desktop website with some code A such as Javascript code that connects with the MCMS hosting server to run some code B to detect the type of device requesting the website, such as a smart phone, a tablet or a desktop PC and return information to help the code A to either render the desktop version of a website or a mobile version of a website.

### DETAILED DESCRIPTION OF THE INVENTION

The system and method described here presents techniques and methods used to provide a Mobile CMS (Content Management System) for creating a mobile websites, as well as converting existing desktop websites into mobile version. A mobile website is a website that is designed with optimizations and considerations for mobile device limitations such as screen, input methods, less processing power, less network bandwidth etc. A mobile website will henceforth be referenced with the acronym MW. The Mobile CMS henceforth will be referred to as MCMS.

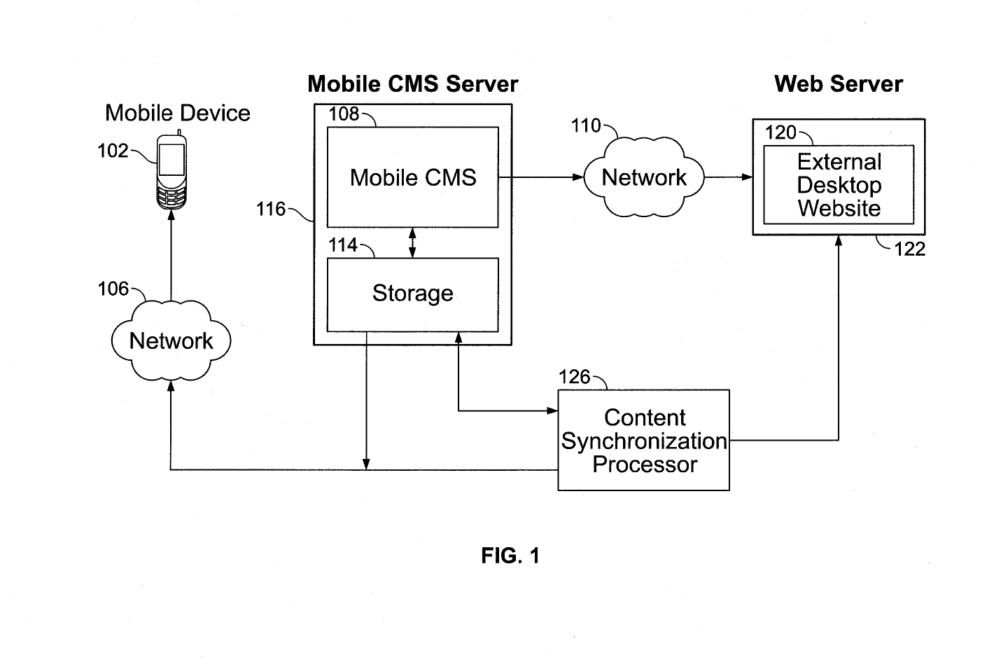

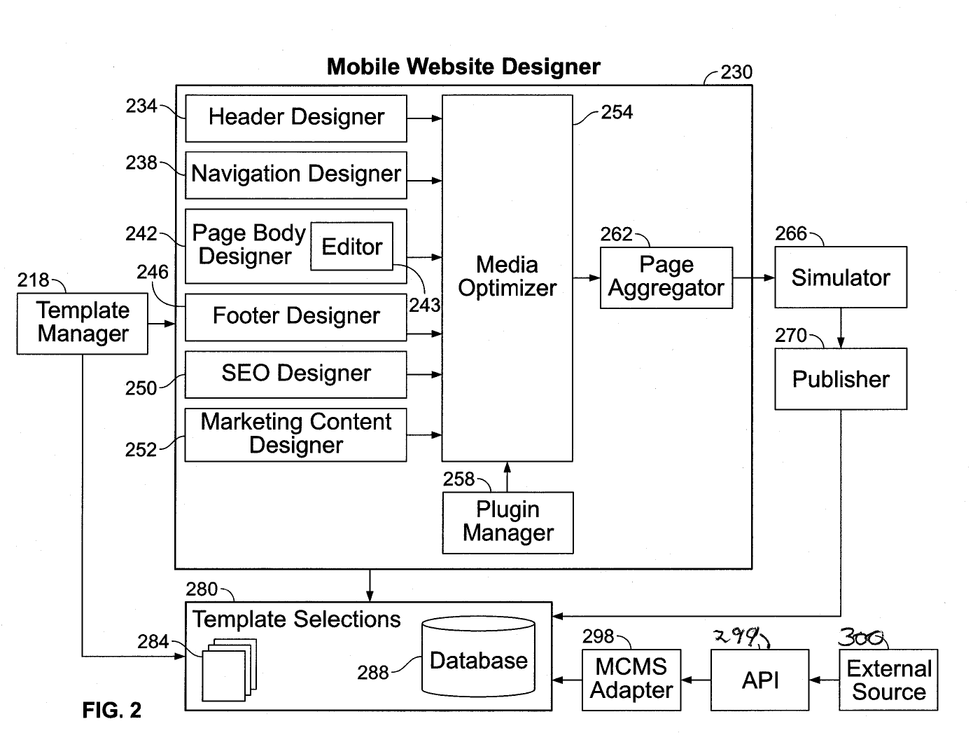

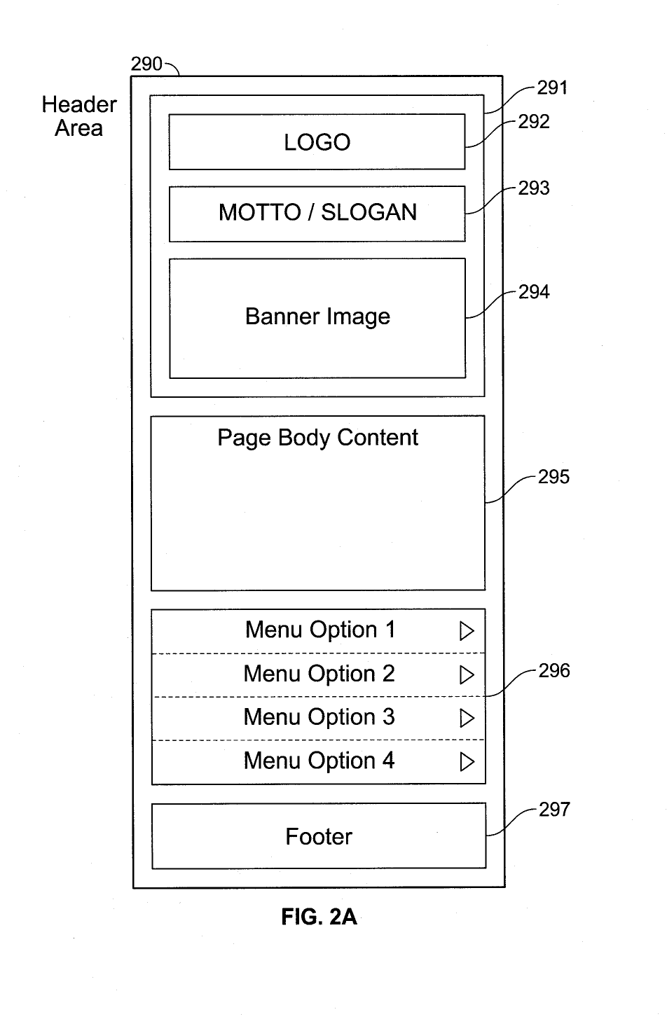

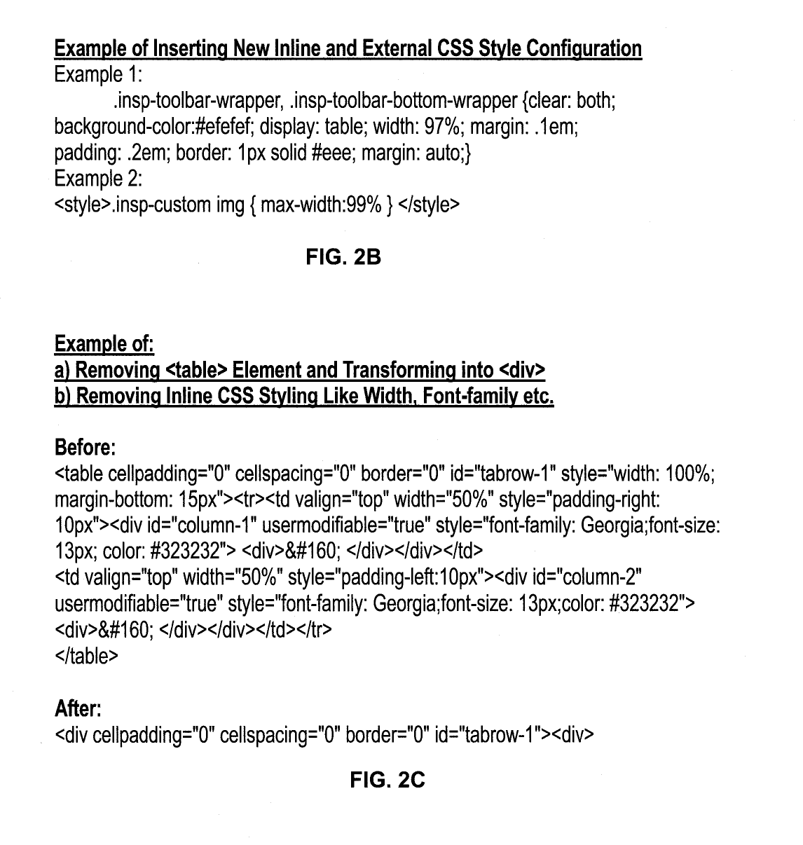

FIG. 1 is a block diagram showing an exemplary system. FIG. 1 describes high level components including. The MCMS may be used by a human operator referred to as the user in this document, who wants to create a MW. The MCMS 108 which runs on an MCMS server 116 and is a software system having several processing components as depicted in FIG. 2 and will be described in more detail in the subsequent paragraphs. The mobile device 102 connects with MCMS 116 and optionally with Content Synchronization Processor 126 to get MW content over a network 106, which may include of a variety of telecommunications (wireless e.g. EDGE/GPRS, GSM, HSPA etc. and wired e.g. SS7, SONET, ATM etc.) and data networks, e.g. Internet Protocol network, Ethernet, WiFi etc. capable of transporting the web content between the M CMS 108 and the mobile device 102. In one aspect of the invention, the mobile CMS 108 connects with the web server 122 over network 110, which may be similar to network 106 in nature and composition as described above, and reads the content of the desktop website 120 for one or more pages as requested by MCMS 108. The MCMS 108 provides capability for a user to create and format a MW and save it in the Storage 114 which is part of the MCMS server 116, but may reside outside of it. The storage 114 may consists of any physical and logical data storage medium such as one or more databases and file systems etc. The database may consist of any form of data management system such as a Relational or Non-Relational Database Management System (RDBMS), whereas the file system may consist of any kind of file organization structure, such as FAT32, NTFS, AFS etc. suitable to store MW content. The Content Synchronization Processor 126 handles content synchronization between desktop website 120 with the MW.

FIG. 2 is a block diagram of an exemplary system showing showing the Mobile Website Designer 230. The Mobile CMS server is the system comprising all hardware and software stated in the invention. The mobile website designer is part of the MCMS application that comprises of a set of functionality to create, edit and optimize mobile website pages. As a content management system, the MCMS is used by a human operator/user needing to create a MW. The user interacts with a Template Manager 218 to choose a template from a choice of Template Selections 284. A template is a structured layout of a MW containing placeholder variables for various components to receive and store actual contents such as a logo, banner image, page body section, navigation objects like menu buttons, and footer contents etc. A template may also support a plurality of other graphic and content features like image galleries, animated content such as JavaScript-based animations, gif animations etc. The Template Manager 218 has the intelligence to recognize and adapt to a variety of compatible layout and style configurations thus providing the user the flexibility to design a MW once but have the option to convert it into a number of compatible templates, preferably with simply a one-click operation.

The Mobile Website Designer 230 consists of multiple modules such as Header Designer 234, Navigation Designer 238 etc. The Mobile Website Designer 230 is an extensible system and can incorporate additional modules to enrich the MW with additional and technologies or features. The user uses each of these modules to create content that is incorporated into the template instance used for this project. Some of the content such as logo, navigation options and footer may be repeated in every web page created in the MW. A sample embodiment of a MW is presented in FIG. 2a and explained in one of the sections below.

The Mobile Website Designer 230 records the content generated by each of the sub-modules into the Storage 280. The storage 280 may consists of any physical and logical data storage medium such as one or more databases and file systems etc. The database 288 can be accessed by standard command interface languages such as SQL or a graphical user interface tool such as SQLYOG, PHPAdmin or from within the MCMS software using an Application Programming Interface such as embedded SQL etc. The database may consist of any form of data management system such as a Relational or Non-Relational Database Management System (RDBMS) e.g. Oracle, MYSQL, SQL Server etc. The file system can be accessed by a screen-based or command-line interface such as Windows Explorer or Unix shell, or from within the MCMS software using file system Application Programming Interface functions typically referred to as File Input/Output system calls such as Open, Close, Read, Write etc. The file system may consist of any kind of file organization structure, such as FAT32, NTFS, and AFS etc.

The Header Designer 234 consists of functionality to create features representing content such as business logo, banner image etc. The Navigation Designer 238 consists of functionality to create controls like clickable menu options that enable a user of the MW to click on them to view various pages. The menu options can take a plurality of forms such as buttons, bars, icons etc. and can be placed anywhere on a page in the MW as defined in the template structure, and can be implemented in a plurality of ways such as a static or an animated menu using a variety of programming methods such as Javascript or Flash etc. Clicking on a menu option may render the contents of the page from the cache represented by the menu option or may perform an action such as fetching content live from an external source, or interact with a data server to obtain information. The Header Designer 234 may also consist of functionality to identify the visitor of the MW and optionally information like compliments to the visitor, or the shopping cart count from a previous visit. The Page body designer 242 enables creating content for one or more web pages as desired by the user and includes a multi-method content editing facility that includes: 1) the ability to type in and include rich content and text like fonts, bulleted and numbered lists, images, graphics, audio, video etc.; 2) the ability to manually incorporate rich content from one or more sources such as by a copy and paste action; 3) the ability to drag and drop content from an external source or an internal source such as a local document stored on user's computer. In another embodiment, the editing facility may support common User Interface elements and controls, such as buttons, text fields, dropdown boxes etc.

The Footer Designer 246 consists of functionality to create content representing the bottom of a web page and includes content such as page links, site map links, copyright messages etc. The Footer Designer 246 may also support intelligent features like page hits, Social Media integration links, Information fetched from Social Media systems such as how many Facebook likes this organization's Facebook page has or how many followers this organization's Twitter page has etc. The SEO Designer 250 consists of functionality to create Search Engine Friendly content inside a web page. The SEO content is typically not a visible element on a page but embedded in the source code of the page. The Search Engine Friendly content consists of information like meta tags, keywords etc. that help make a mobile web App or site easily searchable by Web Search Engines such as Google, Yahoo, Bing etc. Marketing Content Designer 252 is a set of functionality that enables a user to create marketing material such as Advertisement campaigns as mobile content and included in the mobile website. The methods to provide this set of functionality may include a module for creating and editing rich content such as text, images, video etc. for marketing messages. The content may be presented in a variety of forms such as a flash screen upon opening the mobile website on the mobile device, or as part of another page in the created mobile website. The Plugin Manager 258 provides a means to extend the content and features of the MW by enabling the integration of content that may be static, such as an email form or an uploaded image gallery, as well dynamic, such as up-to-date information from another website or from a database-driven interface, from a plurality of sources. The Plugin Manager 258 consists of functionality to integrate extensions in the MW such as Graphical Map for location display, interactive forms to submit inquiries, image galleries, QR code generator, animation etc. In the current embodiment of the invention, the invention makes use of specific and uniquely identifiable tags to indicate inclusion of a plugin module. Other embodiments of the invention may include embedding custom coded features programmed using a combination of one or more of client-side web programming languages like HTML, Cascading Style Sheets, or CSS for short, Javascript, and AJAX. The Media Optimizer 254 (it optimizes various types of content going into each mobile page such as text, rich text and media content) represents a collection of functions to transform and optimize the content, whether fetched from the external source or custom-created using the Editor 243. The transformation, transcoding and optimization may include a variety of actions such as converting relative paths of URLs to absolute URLs or vice versa as needed for improved performance, removing extra blank lines, optimizing images to reduce their size and resolution based on heuristics to result in sufficient quality for small screen mobile devices, converting multi-column table content into fewer columns or linear list of values, removing inline or external CSS attributes such width and/or height, adding inline or external CSS attributes such width and/or height, text font styles, background images etc., restyling one or more HTML elements such as Heading tags like <H1>, <H2>, making the text and images scalable and fluid for adaptation to various device sizes etc.

The mobile devices are usually small screen compared to the desktop. A table-format data usually has one or more columns shown in a grid format. This data is typically coded using <table> (or any other variation of this) element in the HTML language coding. In one embodiment, the MCMS may transcode table elements in a webpage into other HTML language elements such as a <div> and present multiple columns of data as column-value pairs in any suitable display format such as one pair on a line or two pairs on a line. In another embodiment, the MW creator may be given an option to choose a subset of the table columns that can fit into the document yet necessary to convey the meaning.

The MCMS may track information on the access and usage patterns of the MW such as number of site visits, page visits, clicks on certain links on the MW etc. This information may be valuable for the MW owner for understanding customer liking of the information or promotions offered on the MW. The MCMS analytics feature may offer the ability to tabulate this set of data and present to the user using a plurality of rich media format such as text, images, graphs, and animated graphs etc.

A desktop website may have a variety of content elements such as Javascript-based animation, forms for data entry, video, and audio etc. Various mobile devices and the browsers on those devices may handle these elements in different ways or not at all. This has impact on user experience while visiting the MW. The MCMS may detect the device capability and accordingly decide to remove the element during the creation of the MW for improved download performance and user experience.

In one embodiment, the MCMS server may leave the assets such as images, css styles etc. on the external source and reference or utilize them during the live rendering of MW pages. In another embodiment, the MCMS server may download these assets to the local server and reference or utilize them from there during rendering of the MW pages. The MCMS constantly displays a Simulator 266 to the user in the MCMS that automatically shows the optimized MW to preview the generated MW. That Simulator is programmed to present a real mobile-device-like view of the MW as it would appear on the actual mobile device. The Simulator feature is also programmed to display in landscape mode via an option in MCMS.

Website developers or the tools for creating websites often use relative file paths for content resources used on the website. For example, if an image on a website is stored at the location represented by the absolute path of http://www.domain.com/images/image1.jpg, the tool or developer may reference it with relative paths such as images/image1.jpg, or ./images/image1.jpg. The relative paths will work while the user is visiting the desktop site but when the pages are downloaded during MCMS optimization of the website, it may store in a different file path on the MCMS host, and so needs to convert relative paths into absolute paths so that they are accessible in the MW and the web browser on the mobile device can render them.

FIG. 2b, FIG. 2c, and FIG. 2d show some sample codes of some of the transformations by the Media Optimizer. It must be noted that there may be other types of transformations performed on the content. FIG. 2b. is an example of inserting inline as well as external CSS style configuration in the page content. Example 1 in FIG. 2b stylizes a toolbar that appears on top of the resulting MW. FIG. 2c is an example of transformations. The sample HTML code shows that the <table> element is transformed into a <div> element, and the inline CSS has been removed. FIG. 2d shows an example of inserting Javascript and JQuery into the MW to enable dynamic effect of the navigation menu.

The Page Aggregator 262 takes a plurality of pages created by the aforementioned Designer Modules 234 through 258 and organizes these pages as an organized and integrated collection in the form of a MW. The User can launch a Simulator 266 to preview the generated MW and then publish it using the Publisher 270 which creates the necessary database records and files into the Storage 280, which constitute a full functioning MW for user access from mobile devices.

In another embodiment of the invention, a complete set of content conforming to the MCMS's MW defined template structure may be fed into the MCMS backend by way of an Application Programming Interface 299 which takes input according to the specifications and feeds into the MCMS Adapter 298. The input may come from another system local or external to the MCMS environment. Once the content is in the MCMS system, it becomes a full functioning MW able to provide all features and benefits as a MW created from scratch using the MCMS. The external source 300 in FIG. 2 is a system outside of the MCMS that can pass content parts such as logo, banner image, content, navigation menu etc. from a desktop website to create a mobile website. The MCMS may provide an Adapter facility (298) that can be fed these content parts via an API (Application Programming Interface) (299) with interface method calls that an engineer skilled in the art of programming can utilize. The combination of External Source 300, API 299, and MCMS Adapter 298 represents an embodiment of mobile website creation where a user may not need to use the Mobile Website Designer 230 to initially create a mobile website but may use it afterwards to edit and maintain.

After a mobile website is created and published, it is accessible on the internet for users if it is configured in the network for web access. The MCMS may be used to modify the website at any time and may be republished with a one click action which causes the MCMS to perform the optimization of the website, package and save in the storage. Thereafter, the modified version is instantly available to users.

FIG. 2a represents an exemplary MW generated by the MCMS software. These parts belong to a pre-defined template containing structural sections of the MW. The templates may contain more or less structural sections and the MCMS software may be adjusted to support any structure. The graphic layout of the template may be in a variety of styles and designs where some designs may not include one or more of the parts shown in the FIG. 2a. Conversely, additional elements may be included. In addition, the Page Body Content section may be a free-format section that can contain any combination of content such as text, images, color panes, video, audio, forms, tables, charts, graphs, as well controls such as buttons, dropdown lists, checkboxes etc. The MW content is presented as pages, where a page contains content having various sections. The page is contained in the screen frame 290 which serves as the boundaries of the MW. It may contain a Header area 291 that may include a Logo 292 and a Motto or Slogan text line 293. It may also include a Banner image 294 which could be presented with animations such that a plurality of images may rotate to be shown one at a time by using various graphical animation methods such as horizontal image scrolling, vertical image scrolling, fading one image out and another image in etc. The MW may contain a page body 295 containing rich content such as text in various font styles, font weights, bullet list, images, as well as controls such as buttons etc. If there is more than one page in the MW, the page may contain navigation options, also referred to as menu options, for other pages in the MW. The menu options 1 through 4 in FIG. 2A represent an embodiment of a plurality of navigation options to provide a user a method to navigate between pages and within a page in the mobile website. Examples of menu options include typical clickable buttons or links on a website such as Home, About Us, Contact Us etc. The page may also contain a Footer 297 that contains information like site map links, copyright statements, terms of use etc.

The MCMS may provide a toolbar with clickable elements such as icons for quick access to certain information on a website such as the navigation options that may be minimized by default but dynamically opened upon user click, phone number(s), search option to search text on the currently opened page, links to jump to the top or bottom of the page particularly useful on pages with large content.

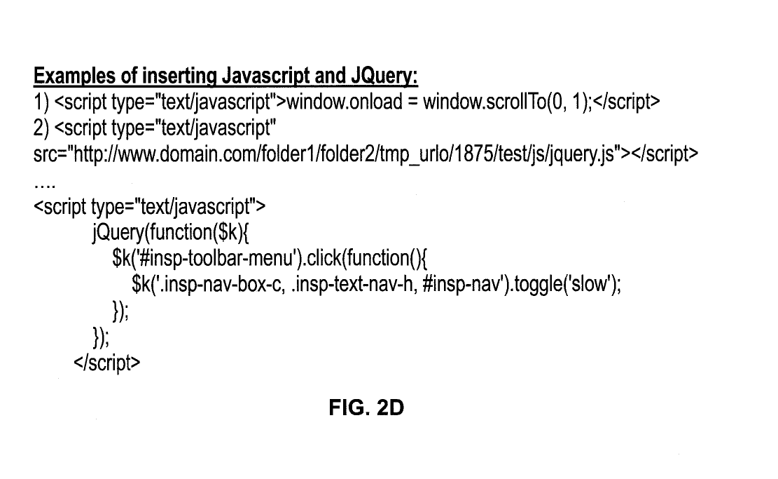

FIG. 3 is a high level flowchart of one embodiment of a scenario of a user using the invention. Referring back to the FIG. 1, a user connects with the MCMS 108 with the purpose of creating a MW. The user starts the process by launching the MCMS software. This flowchart is one embodiment of the processing flow and assumes that the template supports and/or requires the various sections to be created such as the header, the footer, the page body, and the plugins etc. not necessarily in that order. Another embodiment may involve using a default template. The User selects a template in step 310 for the desired layout and supported features. The MCMS may have a facility to further modify the styles and fonts of the various parts of the template selected. The user creates the header section of the MW in step 314, and the footer section of the MW in step 318. The user then proceeds to create the page body content.

At this point, the user has two options for creating the body content of the page. He may choose to design a custom page or create a synchronized page; the latter by populating the page content from another online website, and establishing synchronization between the external source and the local copy. The user may create one or more pages and for each page may decide to create custom page content or a synchronized page. The purpose of creating a custom page may be to manually maintain the content using the MCMS editing features and keep it independent of any external source. On the other hand, the purpose of creating a synchronized page is to let the MW page remain in sync with the external source whenever the external source content changes.

If the user chooses to create a custom page at step 326, the user performs step 330 and creates the custom page and uses the MCMS Editor 243 from FIG. 2 to create the desired content. On the other hand, if the user chooses to create a synchronized page, the user uses a feature of the invention referred to as the Autosync. The Autosync feature involves launches another web browser, henceforth referred to as the child browser, from within MCMS in step 338. The child browser is opened with a user specified external source page, in the form of a web address such as http://www.examplewebsite.com to be displayed. The user then uses the Autosync features to mark and capture content from that page in step 342. The user then publishes the MW in step 350 to make it accessible to mobile device users.

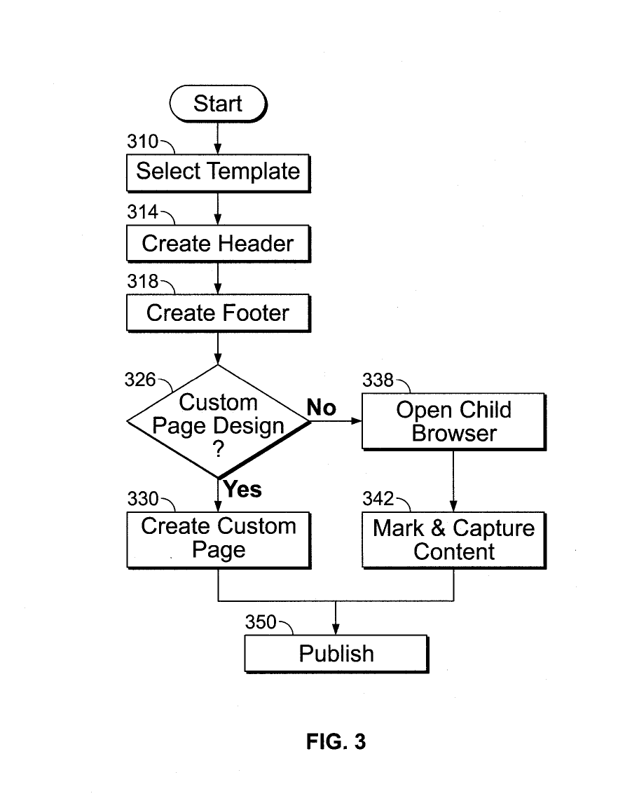

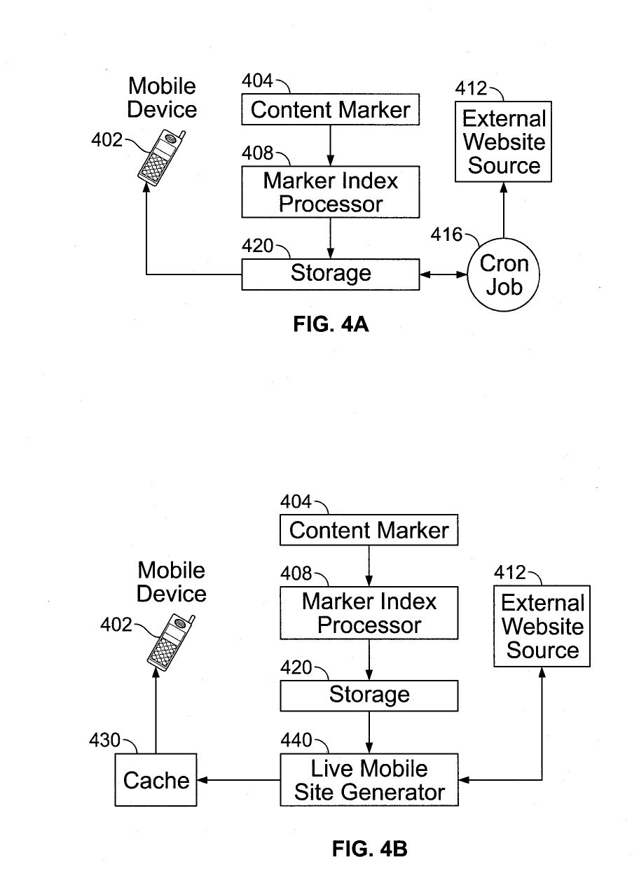

FIG. 4a presents a block diagram for one embodiment of the invention's integration and synchronization method between the external source content and MW content. The Content Marker 404 enables the user to selectively mark some or all of the content on the external source 412 and request the MCMS to track same. The Marker Index Processor 408 uses special techniques including but not limited to, DOM tree parsing, HTML element property manipulation, calculating the hierarchical depth of the HTML elements, tracking the path of the HTML element in the DOM tree in an appropriate notation, calculating digital content hash value of the page and/or marked content using techniques such as checksum etc., using grammar rules to identify and/or compare contents etc., and using heuristic rules to uniquely index and locate the marked contents. All this data is stored in the storage 420 as a ready-made MW which is served to a mobile device 402 upon request. A DOM (Document Object Model) is an Application Programming Interface (API) to navigate and manipulate HTML documents. In this embodiment of the invention, a cron job 416 is provided to periodically wake up and poll external source for changes. The cron job 416 performs this activity for all MWs that have synchronized pages from external sources. The cron job uses data created and stored by Marker Index Processor 408 into the Storage 420 to locate the contents on the external source the user had marked for integration and synchronization with the MW. The cron job 416 may update the data created by the Marker Index Processor 408. In another embodiment of the synchronization, the external source may be modified to be fitted with a method such as a piece of code to watch for changes on the external source and inform MCMS to synchronize the MW content.

FIG. 4b presents a block diagram for another embodiment of the invention's integration and synchronization method between the external source content and MW content. The Content Marker 404 enables the user to selectively mark some or all of the content on the external source page 412 and request the MCMS to track. The Marker Index Processor 408 uses special techniques including but not limited to, DOM tree parsing, HTML element property manipulation, calculating the hierarchical depth of the HTML elements, tracking the path of the HTML element in the DOM tree in an appropriate notation, calculating digital content hash value of the page and/or marked content using techniques such as checksum etc., using grammar rules to identify and/or compare contents etc., and using heuristic rules to uniquely index and locate the marked contents. All this data is stored in the storage 420 as a ready-made MW which is served to a mobile device 402 upon request. However, in this embodiment, no cron job is used. Instead, a process Live Mobile Site Generator 440 is used. A cache 430 may be used to capture the MW pages so that subsequent requests for the pages may be served more efficiently if external source has not been modified since the last cache update. The Generator 440 is invoked the first time the MW is created and the MW page contents are cached for the first time. Thereafter, when a mobile device attempts to access the MW and the MCMS server receives the request to serve the MW pages, the request is passed to the Live Mobile Site Generator 440. The Generator 440 uses indexing data stored by Marker Index Processor 408 into the Storage 420 and visits the external source to compare whether one or more of the external source pages have changed from the last time Generator 440 updated the cache 430. If there has been a change, the Generator 440 indexes into the external source and reads the content for the marked locations for the changed pages and updates indexing data in the Storage 420 as well updates the cache 430 for better performance upon subsequent mobile device 402 requests for MW pages.

In another embodiment of the Autosync feature implementation as shown in FIG. 4a, the user may request synchronization of the full content on a page of an external source. The Content Marker 404 uses various methods including but not limited to the techniques used by the Marker Index Processor 408 to capture the full page content and record markers for it.

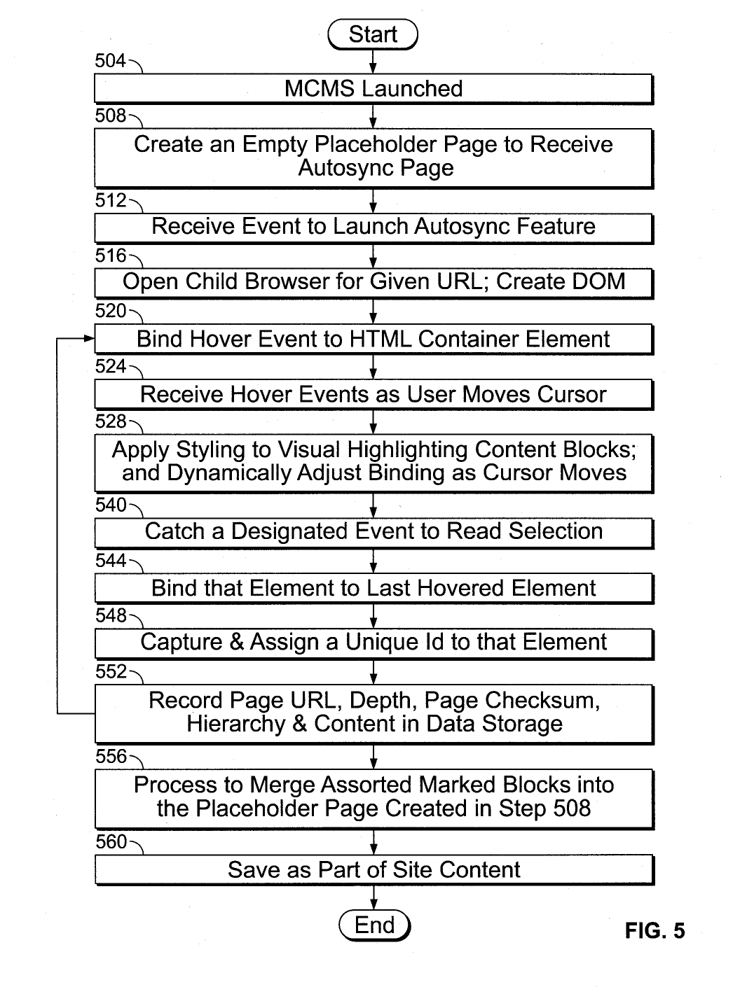

FIG. 5a represents a flowchart describing one embodiment of how the invention provides the capability to MCMS to obtain and integrate selectively marked content from an external source and incorporate into a MW to support automated synchronization between the external source and the MW copy of content. In this embodiment, a page of MW exclusively contains only content from the external source and no custom content. Upon Start, the user logs in to MCMS Server and takes an action such as clicking a button that causes MCMS to launch (step 504). Then the Header and Footer pages are created (step 508). Then the user creates an empty placeholder page to hold the content that will be marked to incorporate into MW from the external source. For each page, the MCMS provides a capability for the user to request the launch of AutoSync feature (step 512). The MCMS opens a child browser (step 516) and opens the page for a user specified webpage URL. The MCMS uses CURL programming language, which allows interacting with a web page using HTTP protocol to fetch the page content for a given URL and then generate a DOM tree for the page. In step 520, the MCMS binds the Hover event to various HTML container elements that may contain data content on the page such as <div>, <body>, <table>, <td>, <img>, <p> etc. A Hover event is a type of mouse device event generated in a web browser application as a mouse moves across the page. After the MCMS application binds the container elements or tags to the hover event, as a mouse moves from one content block tied to one container element to another content block tied to another container element, a hover event is generated, the MCMS application captures that event and in turn visually highlights that content block for ease of visual identification and selection. This allows the MCMS to continuously receive the Hover events as the user moves the cursor around the page (524). The MCMS also dynamically applies styling as such as applying a designated background color to these container elements, so that when the user moves the cursor around on the page, the container element on the page under the cursor gets highlighted (step 528) with the background color. Note that the user may move the cursor around until the user decides which content block is to be included in the MW for auto-synchronization and may then indicate by an event such as a mouse click etc. to the MCMS to mark it. The MCMS receives that event in step 540 to read the content block selection, and in step 544 binds that event to the last hovered HTML container element. Additionally, the background color of the selected content block may be changed to another designated color to indicate to the user that this block has been marked for auto-synchronization. In step 548, the MCMS assigns a unique ID to the HTML element. Then in step 552 the MCMS records in the storage several data items including but not limited to the hierarchical depth of the HTML element, the path of the HTML element in the DOM tree in an appropriate notation, calculation of the digital content hash value of the page and/or marked content using techniques such as checksum etc., grammar rules, and heuristic rules etc. to uniquely index and locate the marked content blocks. This sequence of processing steps from 520 through 552 is repeated for each content block marked by the user. In step 556, all marked content blocks are merged to form a full mobile page for the MW and stored in the Storage as part of the MW content. The sequence of processing steps from 512 through 560 is repeated for each page the user wants to set up auto-synchronization for in the MW. The step 560 involves saving the content blocks and indexing data referenced in step 552 into the storage in the MCMS.

In another embodiment of the design of the selective marking and incorporation process described in the flowchart in FIG. 5, a page may contain both custom content and content from an external source. This is achieved by utilizing a combination of the multiple features of the invention described in the preceding sections including the page Editor 243 in FIG. 2, the tag feature of the Plugin Manager module 258 in FIG. 2, and the Autosync feature described in FIGS. 3, 4a, and 4b.

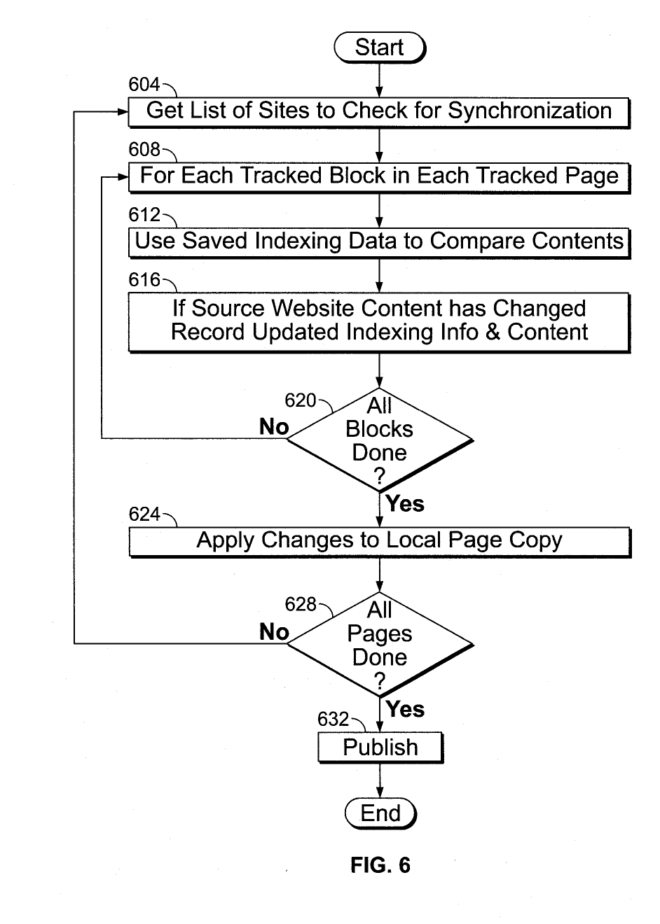

FIG. 6 represents a high level flowchart representing the processing steps for the cron job 416 referenced in FIG. 4a that will maintain synchronization between the content blocks on the external source and their copies that have been included in the MW. A cron job is a program that performs specific processing on a fixed schedule and is configured using the operating system's job scheduling features such as using crontab files in Unix Operating System etc. This embodiment of the processing is applicable to those MW with pages that were created using the AutoSync feature. Upon Start the cron job reads the list of all external source websites for which Autosync feature was used during MW design (step 604). For each tracked page and the content blocks in the pages (step 608), the job uses the indexing data from the storage to compare contents and check for updates in the external source (step 612). If changes are detected, the MCMS indexes the changes for the block (step 616) and continues to process the next content block (620) if there are more, otherwise apply all block content updates to the mobile page (step 624) and store in Storage. If there are more pages, process them in the same way (628), else publish (step 632) the MW which replaces the old version of the MW, and complete the flow.

In another embodiment of the synchronization method, a piece of code may be written as a client-side script or server side script in a programming language such as Javascript and embedded in the external source such as a desktop website. This piece of code may detect if any pages on the desktop site have changed and call the MCMS server to go and perform the synchronization.

In the above specification details, the invention has been described with various embodiments and examples of possible implementation approaches. The purpose of these embodiments and sample implementations is only to provide clarity on the novel aspects of the design in a broad sense and not in a restrictive sense. It may also be noted that the drawings do not necessarily include every low level technique that may be implemented in a variety of ways by anyone skilled in the art.

The method may include steps to configure Domain Name System, also referred to as DNS, on other web server hosts to point a subdomain such as ‘m’ e.g. m.domain.com, to point to the web server host hosting the MW's created by use of MCMS. The method may include steps to configure the hosting web server to point the incoming requests for accessing the MW to the folder where the generated MW is installed. This configuration may be done by adding an A or CNAME record to point to the IP address or the domain name respectively of the MCMS hosting server. The web server hosting the MW's may be the same as the web server running the MCMS software.

If a desktop version of a website exists and a mobile version is being created with the use of MCMS, a redirection method needs to be implemented. This includes steps to configure an existing desktop website with some code A such as Javascript code that connects with the MCMS hosting server, passing the calling mobile device's User Agent information, to run some code B to detect the type of device requesting the website, such as a smart phone, a tablet or a desktop PC and return information to help the code A to either render the desktop version of a website or a mobile version of a website. The MCMS hosting server contains specific code, referred above as code B, to read the User Agent information and processes it to identify the type of mobile device requesting the webpages and the attributes related to the device's hardware and software to support appropriate rendering and content inclusion for the mobile device according to the mobile device's capabilities.

In one embodiment of the invention, the mobile website can be created as integrated into the MCMS cloud server environment as described in this document. In another embodiment, the mobile website can be extracted as a stand-alone package that can be deployed on any hosting server using standalone website installation methods. This can be achieved by storing mobile website content using a plurality of storage facilities such as a file system or database. The resulting package may not have a depending on any resources of the MCMS environment.

I claim:

1. A system for generating a website usable on a mobile device, comprising:
a mobile content management server having a mobile content management module and a storage module;
the mobile content management module capable of generating structural attributes or indexing the location and structural attributes of a website on a network;
the mobile content management module capable of converting said structural attributes into a website suitable for display on a mobile device; wherein, the content management module has at least one of the following features selected from the group consisting of:
a) plugin extensibility and seamless integration into mobile site development,
b) embedded link processing to enable mobile optimization of any number of pages on a desktop site,
c) an API Adapter to receive content from an external source to generate a mobile website,
d) 1-click site republishing,
e) co-existence of desktop synchronized and custom content, and
f) ability to either setup and serve the resulting mobile website from the integrated MCMS cloud server environment or extract as a stand-alone mobile website package deployable on any other hosting environment.

2. The system of claim 1, wherein said system further contains a content synchronization processor.

3. The system of claim 1, wherein said system further has a rich media editing facility with HTML/CSS support.

4. The system of claim 1, wherein said system further has 1-click template selection and switching method.

5. The system of claim 1, wherein said system further has the ability to receive custom rich media that does not exist on the desktop website.

6. The system of claim 1, wherein said system further comprises mobile statistics/analytics data and reporting capability.

7. The system of claim 1, wherein the resulting mobile website or web application is cached.

8. The system of claim 1, wherein the system provides instantaneous visibility of edited and republished mobile website content.

9. The system of claim 1, wherein the system has a mobile device/smartphone-like emulator to preview results.

10. The system of claim 1, wherein the system can support multiple site projects from one user account.

11. The system of claim 1, wherein the system can convert an HTML Table to 1-column linear output or a table with a subset of columns.

12. The system of claim 1, wherein the system can remove, add, or modify JS code, forms, flash, video, or sound.

13. The system of claim 1, wherein the system removes or adds blank lines for improved content display.

14. The system of claim 1, wherein system can adapt to resource paths in an external source website.

15. The system of claim 1, wherein the system optimizes images and URLs using heuristics and calculated resizing.

16. The system of claim 1, wherein the mobile website can be generated in any HTML standard.

17. The system of claim 1, wherein the rich editor supports WYSIWYG, visual presentation, or HTML/JS/Ajax.

18. The system of claim 1, wherein the interface uses click, drag or insert functions.

19. The system of claim 1, wherein the system can incorporate a toolbar in the mobile website.

20. The system of claim 1, having an intelligent template management module/layout engine supporting groups of template designs and suitable for placing content into stylized templates.

21. The system of claim 1, wherein the system creates search-engine friendly page designs and inserts website tracking scripts.

22. The system of claim 1, wherein the system has a one-click switching mechanism between templates.

23. The system of claim 1, wherein the system has the facility to modify color and text fonts for any part of the mobile website selected from header, body, footer, and navigation or combinations thereof.

24. The system of claim 1, wherein the system has the facility to place navigation on the top or bottom.

25. The system of claim 1, wherein the system can launch a child browser.

26. The system of claim 1, wherein the system has a synchronization server, and the synchronization server has smart trackers to index pages.

27. The system of claim 1, wherein the system has external source content update detection.

28. The system of claim 1, wherein the system has a hover feature.

29. The system of claim 1, wherein the system has a platform capable of supporting an extensible list of plugins selected from image gallery, image slider, marketing campaign, rewards, charitable donation, QR code generation, survey, eCommerce, or fetching live information from an external website source or from mobile device the mobile website is running on.

30. The system of claim 1, wherein the system has an adapter designed to take data from other processing systems.

31. The system of claim 1, wherein the system has white-label capabilities powered by <partner firm>, which enables the mobile content management server to present with a partner credentials such as logo and other business reference information.
